(19) United States
(12) Patent Application Publication
(10) Pub. No.: US 2005/0128530 A1
(43) Pub. Date: Jun. 16, 2005

(54) Image projection control apparatus capable of displaying a plurality of images

(75) Inventors: Yoshikatsu Aiba, Tokyo (JP); Yasushi Hikichi, Tokyo (JP)

Correspondence Address: Paul J. Esatto, Jr.;Scully, Scott, Murphy & Presser, 400 Garden City Plaza, Garden City, NY, 11530, US

(73) Assignee: NEC Viewtechnology, Ltd., Tokyo (JP)

(21) Appl. No.: 11/014,539

(22) Filed: Dec. 16, 2004

(30) Foreign Application Priority Data
Dec. 16, 2003 (JP) 2003-418083

(51) Int. Cl. H04N 1/40

(52) U.S. Cl. 358/471; 358/448

(57) ABSTRACT

An image projection control apparatus is connected to a plurality of data processors for generating image data, and displays a plurality of images projected onto a screen by a display unit based on the image data generated by the data processors. The image projection control apparatus includes an image controller for editing the image data supplied from the data processors and for outputting the edited image data to the display unit, and an image manipulator for controlling the image control means and the data processors. The image manipulator has a pointing device for displaying a pointer movably on a screen image on the screen and selecting a command indicated by the pointer for execution, a data processor selector for selecting one of the data processors which generates the image data corresponding to the image where the pointer is presently positioned, and an execution instructing unit for instructing the selected data processor to execute the indicated command.

### BACKGROUND OF THE INVENTION

1. Field of the Invention

The present invention relates to an image projection control apparatus, and more particularly to an image projection control apparatus which is capable of displaying a plurality of images.

2. Description of the Related Art

As projectors are becoming smaller in size and higher in performance owing to rapid advances in the liquid crystal technology and the DLP (registered trademark) (Digital Light Processing) technology, projectors for projecting images are finding a wider range of applications. Projectors have evolved from the initial function of imaging a material placed on a stand and projecting the image onto a screen, to a modern application where a projector is connected to a computer and projects image data generated by the computer onto a screen. Some projection screens are so large that one screen is broken up into a plurality of screen areas for displaying respective images transmitted from a plurality of computers.

Conventional presentation systems have an image projection control apparatus such as a projector. For an image projection control appararatus to remotely control a data processor such as a personal computer for outputting image information, one image projection control apparatus is basically connected to one data processor. When a plurality of data processors are to be used, they are connected to a network, and the data processors are remotely controlled one at a time by the image projection control apparatus. To change data processors so that they can be remotely controlled, their connections need to be changed in order to connect the desired data processor to the image projection control apparatus.

Japanese laid-open patent publication No. 2002-55808 discloses a multi-display system having a plurality of display units and a plurality of personal computers connected thereto to share one pointing device, which simultaneously sends signals to all the personal computers for controlling images to be displayed on the display units. Japanese laid-open patent publication No. 2002-323968 reveals a multi-computer system having a plurality of computers, a console device having an input unit and a display unit for displaying various data processed by the computers, and a connecting device for connecting the I/O ports of the computer to the console device. The connecting device comprises a computer connection definition table which defines computers to be connected based on cursor information, a computer switcher for switching to a defined computer to be connected when it obtains cursor information from the input unit, indicating that the cursor has moved outwardly from an end of the screen of the display unit, and a display controller for displaying data processed by the connected computer on the display unit.

With the conventional presentation system, when a plurality of presenters make their presentations using respective data processors, it is necessary to reconnect the data processor to the image projection control apparatus each time a different presenter takes a turn. Alternatively, it is necessary to collect presentation data beforehand in a single presentation data processor that is connected to the image projection control apparatus.

According to the disclosure of Japanese laid-open patent publication No. 2002-55808, the single pointing device controls the computers connected to the respective display units. The disclosed multi-display system employs plural display units, such as projectors or the like, in presentations, and is not applicable to presentations for projecting images from plurality of computers and a single projector. The multi-computer system disclosed in Japanese laid-open patent publication No. 2002-323968 is unable to simultaneously display data from the plural computers on the display unit although displayed image data from one computer can be switched to other image data from another computer.

### SUMMARY OF THE INVENTION

It is an object of the present invention to provide an image projection control apparatus having an image outputting function, which is capable of displaying a plurality of images by selecting a plurality of data processors for processing presentation data and which are connected to the image projection control apparatus, and controlling images from the data processors.

According to the present invention, there is provided an image projection control apparatus which is connected to a plurality of data processors for generating image data, and displaying a plurality of images projected onto a screen by a display unit based on the image data generated by the data processors. The image projection control apparatus has image control means for editing the image data supplied from the data processors and for outputting the edited image data to the display unit, and image manipulating means for controlling the image control means and the data processors. The image manipulating means includes a pointing device for displaying a pointer movably on a screen image on the screen and for selecting a command indicated by the pointer for execution, data processor selecting means for selecting one of the data processors which generates the image data corresponding to the image where the pointer is presently positioned, and selected command execution instructing means for instructing the selected data processor to execute the indicated command.

The images projected onto the screen based on the image data may be switchable between a display mode in which the images are displayed in a predetermined pattern and a display mode in which only the image where the pointer is presently positioned is displayed. A symbol indicating the selected data processor may be displayed on the image where the pointer is presently positioned and which is based on the image data generated by the selected data processor. The symbol may comprise a colored image frame or a highlighted image frame. The data processors and the image projection control apparatus may be interconnected by a network.

According to the present invention, the data processors connected to the single image projection control apparatus may be selected from the corresponding images displayed on the screen with the pointer controlled by the pointing device, and the image corresponding to the selected data processor may be controlled with the pointer.

A presentation system wherein the data processors are connected to the single image projection control apparatus for displaying the images corresponding to the data processors on the screen, allows the images to be switched thus enabling a smooth presentation without the need for complex operations.

The above and other objects, features, and advantages of the present invention will become apparent from the following description with reference to the accompanying drawings, which illustrate examples of the preferred embodiment of the present invention.

### BRIEF DESCRIPTION OF THE DRAWINGS

FIG. 1 is a block diagram of an image projection control apparatus which is capable of displaying a plurality of images according to the present invention;

FIG. 2 is a block diagram of a remote desktop presentation system which incorporates the image projection control apparatus according to the present invention;

FIG. 3 is a schematic perspective view of the remote desktop presentation system;

FIGS. 4(a) and 4(b) are views showing how an image changes when a pointer moves on the screen;

FIGS. 5(a) and 5(b) are views showing how an image changes when one of the divided images is enlarged; and

FIG. 6 is a flowchart of an image display sequence represented by a processing flow between a pointing device, an image projection control apparatus, and a data processor.

### DETAILED DESCRIPTION OF THE PREFERRED EMBODIMENT

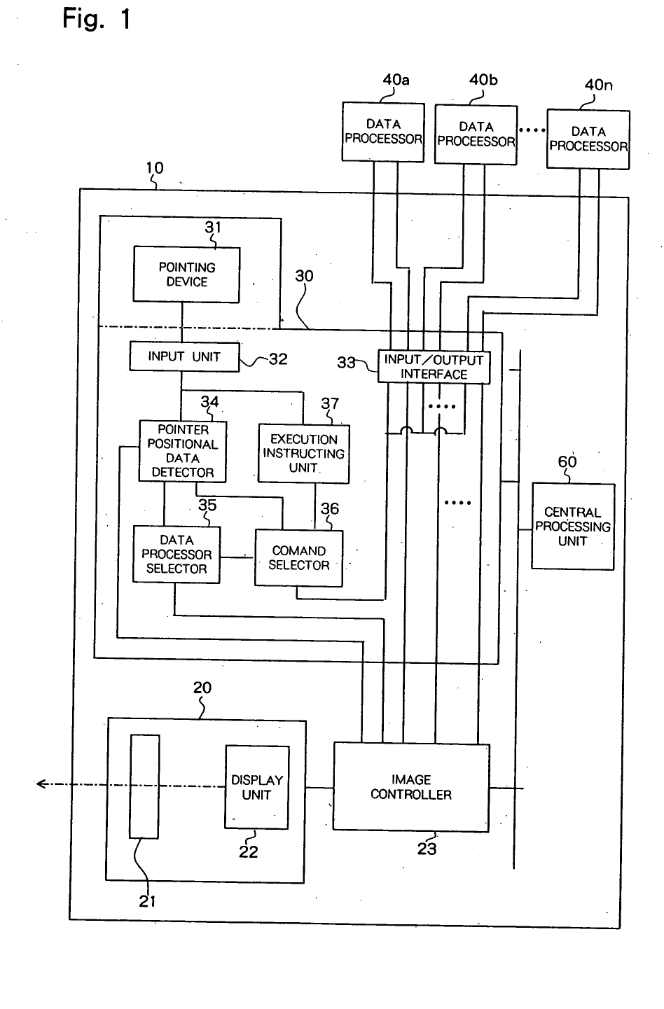

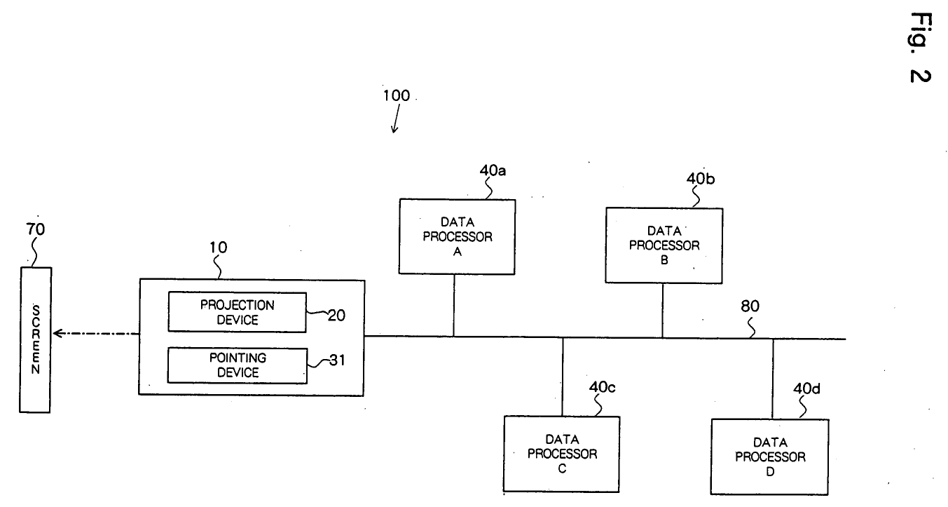

As shown in FIGS. 1 and 2, image projection control apparatus 10 which is capable of displaying a plurality of images according to the present invention comprises an image projection control apparatus which is capable of simultaneously displaying images transmitted from a plurality of data processors 40a, 40b, . . . 40n connected for example to network 80. Image projection control apparatus 10 is characterized in that when a pointer is moved to the display area of one of the data processors 40a, 40b, . . . 40n on screen 70, by pointing device 31 of image projection control apparatus 10, control over the data processor whose display area has been accessed by the pointer, is automatically taken over by pointing device 31 of image projection control apparatus 10.

In remote desktop presentation system 100 which incorporates image projection control apparatus 10, such as a projector, connected to network 80, image projection control apparatus 10 simultaneously displays images supplied from data processors 40a, 40b, . . . 40n through network 80 on screen 70. At this time, simply by moving the pointer to the displayed image from one of data processors 40a, 40b, . . . 40n, the positional data of the pointer is sent to that data processors 40a, 40b, . . . 40n to make it possible to control the data processor. Therefore, it is not necessary to manually change the connections between data processors 40a, 40b, . . . 40n and image projection control apparatus 10, thereby providing excellent data processor controllability.

As shown in FIG. 1, image projection control apparatus 10, such as a projector, which is capable of displaying a plurality of images comprises projection device 20 having projection lens 21 and display unit 22, image controller 23 for controlling images displayed on display unit 22, image manipulator 30, and a central processing unit 60 for controlling overall operation of image projection control apparatus 10. An image formed on display unit 22 by image controller 23 is projected through projection lens 21 onto screen 70.

Image manipulator 30 comprises pointing device 31 for projecting a pointer onto screen 70 and moving the pointer on screen 70, input unit 32 for entering positional information and execution instructing information from pointing device 31, input/output interface 33 for receiving information from and sending information to data processors 40a, 40b, . . . 40n which are connected to image projection control apparatus 10 through network 30, pointer positional data detector 34 for detecting pointer positional data based on the positional information from pointing device 31, data processor selector 35 for selecting one of data processors 40a, 40b, . . . 40n from pointer positional data which corresponds to the position represented by the pointer positional data, command selector 36 for selecting a command from pointer positional data which corresponds to the position represented by the pointer positional data, and execution instructing unit 37 for instructing image controller 23 or connected data processors 40a, 40b, . . . 40n to execute a command selected by the execution instructing information from pointing device 31. Image manipulator 30 switches between and selects image frames on the projection screen based on commands selected by the pointer, and performs a control process corresponding to a pointer at one of data processors 40a, 40b, . . . 40n which corresponds to the pointer.

As shown in FIG. 2, remote desktop presentation system 100 which incorporates image projection control apparatus 10 is constructed of image projection control apparatus 10, a plurality of data processors 40a, 40b, . . . 40n, and screen 70. Image projection control apparatus 10 and data processors 40a, 40b, . . . 40n are interconnected by network 80 such as a LAN or the like. Image projection control apparatus 10 has projection device 20 and pointing device 31. Projection device 20 projects information sent from data processors 40a, 40b, . . . 40n as images onto screen 70. Pointing device 31 selects the image of one of data processors 40a, 40b, . . . 40n from the images projected onto screen 70 and controls the processing operation of that data processors 40a, 40b, 40n based on the manipulation of the pointer projected onto screen 70.

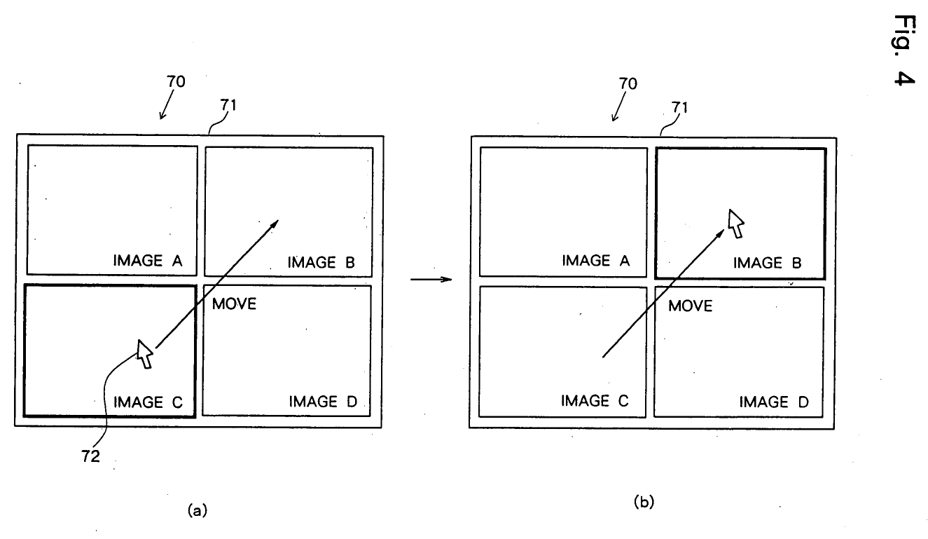

Image projection control apparatus 10 is able to divide an image which is projected onto screen 70 from image projection control apparatus 10 into as many images as the number of data processors 40a, 40b, . . . 40n connected to image projection control apparatus 10, and can display together the images corresponding to data processors 40a, 40b, . . . 40n. Image projection control apparatus 10 also displays, on screen 70, pointer 72 (see FIG. 4(a)) that can be manipulated by pointing device 31. When pointer 72 is manipulated by pointing device 31, image projection control apparatus 10 can perform the function of automatically selecting one of data processors 40a, 40b, . . . 40n depending on the displayed position of pointer 72, and the function of operating one of selected data processors 40a, 40b, . . . 40n.

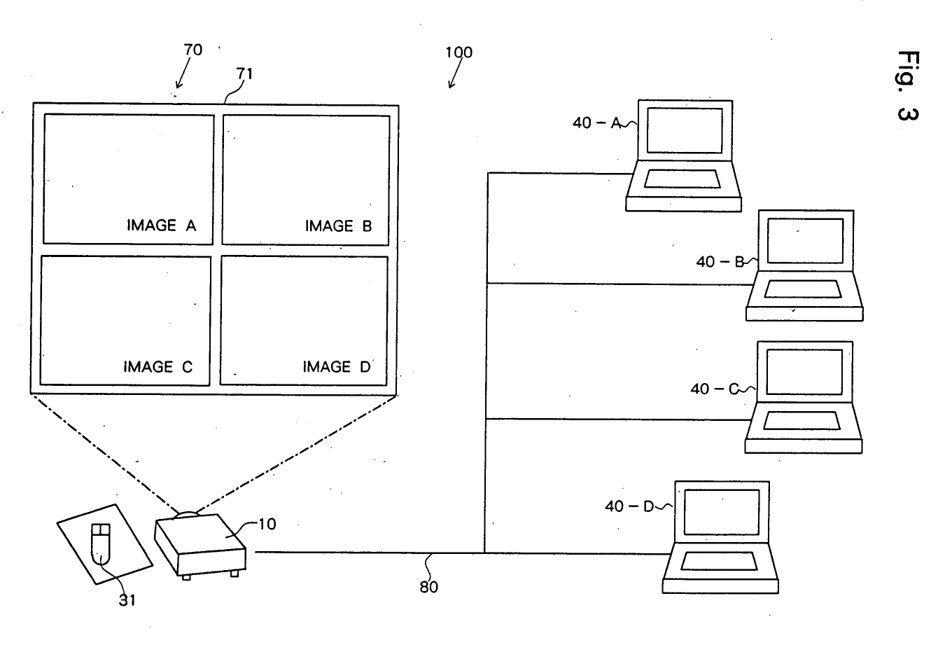

Operation of image projection control apparatus 10 which is capable of displaying a plurality of images according to the present invention will be described in detail below with reference to FIGS. 3 through 6.

As shown in FIG. 3, four data processors 40-A, 40-B, 40-C, 40-D and single image projection control apparatus 10 are connected to each other by network 80 such as a LAN or the like. Images from data processors 40-A, 40-B, 40-C, 40-D are supplied through network 80 to image projection control apparatus 10, which displays the images separately on screen image 71 that is projected onto screen 70. In FIG. 3, four divided images A, B, C, D corresponding to respective data processors 40-A, 40-B, 40-C, 40-D are displayed respectively in upper left, upper right, lower left, and lower right areas of screen 70. The divided images are not limited to four images A, B, C, D. The number of divided images may be selected by displaying a command for image dividing conditions on screen 70 with a click button, other than the usual execution click button, on pointing device 31, and moving the pointer and clicking the execution click button to select an image dividing condition. Alternatively, image projection control apparatus 10 may have a selection button for selecting the number of divided images.

FIGS. 4(a) and 4(b) show how an image changes when pointer 72 moves on screen image 71 that is projected onto screen 70. FIG. 4(a) shows pointer 72 positioned on image C, and FIG. 4(b) shows pointer 72 that has moved from image C to image B. As shown in FIGS. 4(a) and 4(b), pointer 72 controlled by pointing device 31 which manipulates image projection control apparatus 10 is positioned on screen image 71 that is projected onto screen 70. Pointer 72 can be freely moved on screen image 71 by pointing device 31. When pointer 72 is positioned on one of divided images A, B, C, D corresponding to respective data processors 40-A, 40-B, 40-C, 40-D, a symbol indicating that the image is selected by pointer 72, e.g., a colored image frame or a highlighted image frame, is displayed,on the selected image, and a command may be selected from a displayed menu bar and clicked by pointer 72 to remote control the data processor corresponding to the selected image.

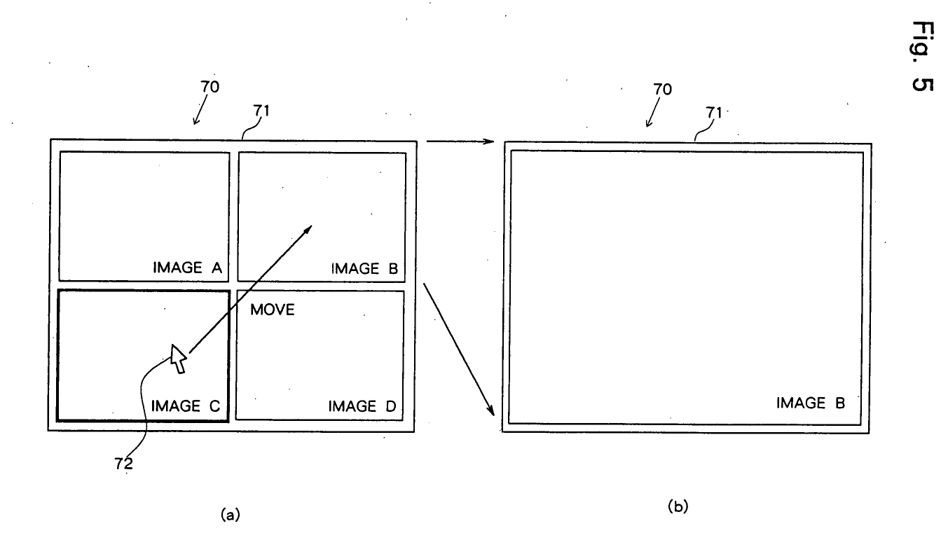

FIGS. 5(a) and 5(b) show how an image changes when one of divided images A, B, C, D is enlarged. As shown in FIG. 5(a), when one of divided images A, B, C, D, i.e., image C, is selected by pointer 72 and a symbol is displayed on image C, the click button on pointing device 31 may be specially operated in a specific way, e.g., the selection button on pointing on device 31 may be double-clicked, to automatically change the size of image C to the size of full screen image 71 that is projected from image projection control apparatus 10. In this manner, one of data processors 40-A, 40-B, 40-C, 40-D that is to be used can easily be selected, and an image corresponding to the selected data processor can be displayed on an enlarged scale for remotely controlling the selected data processor.

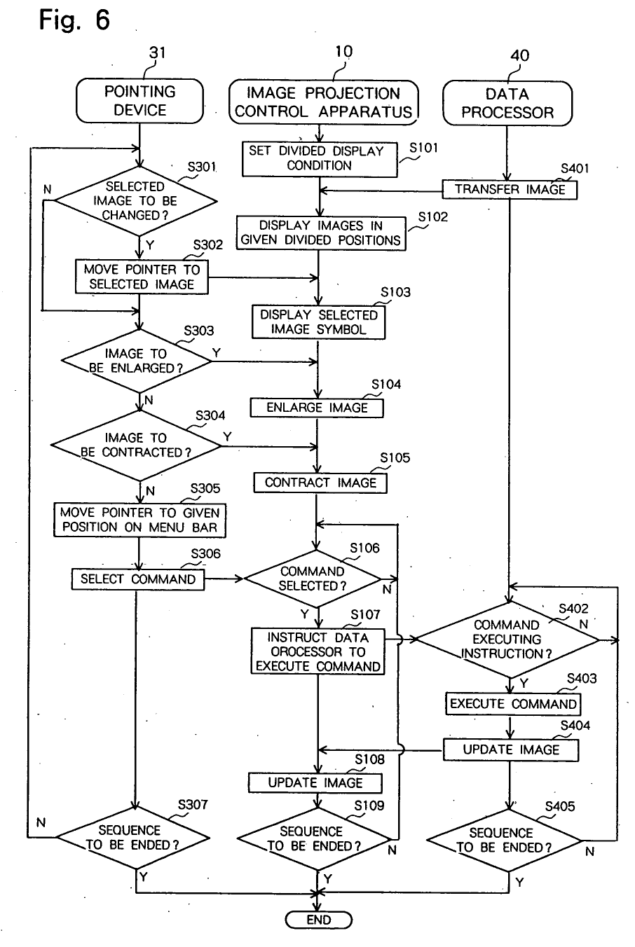

The image display sequence of remote desktop presentation system 100 which incorporates image projection control apparatus 10 will be described below with reference to FIG. 6.

First, image projection control apparatus 10 sets a divided display play condition (S101). Data processors 40-A, 40-B, 40-C, 40-D transfer their respective image data to image projection control apparatus 10 (S401), which projects images based on the image data onto screen 70 according to divided display condition (S102). If a selected image is not to be changed, then pointing device 31 goes to step S303 (S301 N). If a selected image is to be changed (S301Y), then pointing device 31 moves pointer 72 to a newly selected lected image (S302), and image projection control apparatus 10 displays a symbol on the selected image (S103). If the selected image is not to be enlarged, then pointing device 31 goes to step S304 (S303N). If the selected image is to be enlarged (S303Y), then a specific input for image enlargement is entered, and image projection control apparatus 10 displays the selected image at an enlarged scale (S104). If the selected image is not to be contracted, then pointing device 31 goes to step S305 (S304N). If the selected image is to be contracted (S304Y), then a specific input for image contraction is entered, and image projection control apparatus 10 displays the selected image at a contracted scale (S105).

Pointing device 31 moves pointer 72 to a specific position on the displayed menu bar (S305), and is clicked to select a command (S306). If the processing sequence is to be ended (S307Y), then the processing sequence is terminated. If the processing sequence is not to be ended (S307N), then pointing device 31 goes back to step S301.

Image projection control apparatus 10 waits for a command to be selected (S106N). If a command is selected (S106Y), then image projection control apparatus 10 instructs the selected data processor to execute the command (S107).

The data processor waits for a command executing instruction (S402N). If there is-a command executing instruction (S402Y), the data processor executes a command (S403), and updates the image (S404). If the processing sequence is to be ended (S405Y), then the processing sequence is terminated. If the processing sequence is not to be ended (S405N), then the data processor goes back to step S402.

In response to the updated image from the data processor, image projection control apparatus 10 updates the projected image (S108). If the processing sequence is to be ended (S109Y), then the processing sequence is terminated. If the processing sequence is not to be ended (S109N), then image projection control apparatus 10 goes back to step S106.

According to the above processing sequence, an image to be used for a presentation can be selected and enlarged or contracted, if necessary, and one of data processors 40-A, 40-B, 40-C, 40-D which is outputs the image can be controlled by pointing device 31 of image projection control apparatus 10.

It is to be understood, however, that although the characteristics and advantages of the present invention have been set forth in the foregoing description, the disclosure is illustrative only, and changes may be made in the arrangement of the parts within the scope of the appended claims.

1. An image projection control apparatus that is connected to a plurality of data processors for generating image data, and for displaying a plurality of images projected onto a screen by a display unit based on the image data generated by said data processors, comprising:
image control means for editing the image data supplied from said data processors and for outputting the edited image data to the display unit; and
image manipulating means for controlling said image control means and the data processors;
said image manipulating means comprising:
a pointing device for displaying a pointer movably on a screen image on the screen and selecting a command indicated by said pointer for execution;
data processor selecting means, for selecting one of said data processors which generates the image data corresponding to the image where said pointer is presently positioned; and
selected command execution instructing means for instructing the selected data processor to execute the indicated command.

2. An image projection control apparatus according to claim 1, wherein said images projected onto the screen based on the image data are switchable between a display mode in which the images are displayed in a predetermined pattern and a display mode in which only the image where said pointer is presently positioned is displayed.

3. An image projection control apparatus according to claim 1, wherein a symbol indicating of the selected data processor is displayed on the image where said pointer is presently positioned and which is based on the image data generated by the selected data processor.

4. An image projection control apparatus according to claim 3, wherein said symbol comprises a colored image frame.

5. An image projection control apparatus according to claim 3, wherein said symbol comprises a highlighted image frame.

6. An image projection control apparatus according to claim 1, wherein said data processors and said image projection control apparatus are interconnected by a network.
